(19) United States
(12) Patent Application Publication
(10) Pub. No.: US 2014/0239743 A1
(43) Pub. Date: Aug. 28, 2014

(54) XENO TRANSDUCTION SYSTEM

(71) Applicant: JAMES EDWARD JENNINGS, Superior, CO (US)

(72) Inventor: JAMES EDWARD JENNINGS, Superior, CO (US)

(21) Appl. No.: 13/778,476

(22) Filed: Feb. 27, 2013

(51) Int. Cl. H02J 17/00

(52) U.S. Cl. CPC H02J 17/00
USPC 307/149

(57) ABSTRACT

An oscillation frequency power amplification circuit is disclosed herein having improved power and frequency receiver characteristics. The power circuit is characterized by having atmospheric capacitance of device electronic amplify resonate by antenna vessel. Piezoelectrically, a high power device is disclosed that encompasses at least some or all of the techniques described above to achieve an amplification that exhibits both high power and frequency characteristics. The handheld phone, media player, EKG device comprises a number of EKG electrodes and a mood media auto select unit connected to the EKG electrodes sensor amplification transducer.

### BACKGROUND OF THE INVENTION

1. Field of the Invention

The present invention relates generally to Xeno Transduction System and circuits, and in particular, to receiving and fabricating methods for providing improved bandwidth performance and power handling capability of frequency power devices and circuits. My invention relates to Power frequency/power devices wireless telegraphy and more particularly to a piezoelectric oscillation-tube detector which, in addition to performing the usual functions of such detectors, may be used as a tuning device and as a receiver transistor, and which has a variety of other uses.

2. Description of Related Art

The “Fleming valve” was an evacuated glass envelope in which a light-bulb-style metallic filament, fed by low voltage and sucking high current, incandescent at 2000° F. This creates an electrical activity (or, in quantum parlance, “electron flow”) that conducts unidirectional through vacuum to another nearby element, a metallic plate charged to a high positive potential. Thus was a rectifier, and hence also a frequency detector. Lee DeForest discovered that electrical activities within a tube can be leveraged at will by applying small fluctuations to a metallic grid interposed between filament and plate. Tesla's detector and electric car “We now have power.”

A kilowatt is a unit of power. This means that it is an instantaneous measure of consumption rate. To be specific, a kilowatt is a thousand watts. A watt is a joule per second. And a joule is a unit of energy. So, kilowatts are a measure of energy used per time. To use a familiar simile, kilowatts are like miles per hour in your car. Kilowatts tell you how fast you are using energy.

Energy in electronic elements: Electric potential energy, or electrostatic potential energy, is a potential energy (measured in joules) that results from conservative Coulomb forces and is associated with the configuration of a particular set of point charges within a defined system. The term “electric potential energy” is used to describe the potential energy in systems with time-variant electric fields, while the term “electrostatic potential energy” is used to describe the potential energy in systems with time-invariant electric fields.

Capacitance is the ability of a body to store an electrical charge. Any body or structure that is capable of being charged, either with static electricity or by an electric current, exhibits capacitance. A common form of energy storage device is a parallel-plate capacitor. In a parallel plate capacitor, capacitance is directly proportional to the surface area of the conductor plates and inversely proportional to the separation distance between the plates. If the charges on the plates are +q and −q, and V gives the voltage between the plates, then the capacitance C is given by

C=Q/V.

The capacitance is a function only of the physical dimensions (geometry) of the conductors and the permittivity of the dielectric. It is independent of the potential difference between the conductors and the total charge on them.

Piezoelectricity is the combined effect of the electrical behavior of the material:

D=εE

where D is the electric charge density displacement (electric displacement), ε is permittivity and E is electric field strength, and

Hooke's Law: S=sT

where S is strain, s is compliance and T is stress.

In the case of a closed path in the presence of a varying magnetic field, the integral of the electric field around a closed loop may be nonzero; one common application of the concept of emf, known as “induced emf” is the voltage induced in a such a loop.[25] The “induced emf” around a stationary closed path C is:

ε= [symbol] c E·dl,

where now E is the entire electric field, conservative and non-conservative, and the integral is around an arbitrary but stationary closed curve C through which there is a varying magnetic field. Note that the electrostatic field does not contribute to the net emf around a circuit because the electrostatic portion of the electric field is conservative (that is, the work done against the field around a closed path is zero).

Copolymers: Copolymers of PVDF are also used in piezoelectric and electrostrictive applications. One of the most commonly-used copolymers is P(VDF-trifluoroethylene), usually available in ratios of about 50:50 wt % and 65:35 wt % (equivalent to about 56:44 mol % and 70:30 mol %). Another one is P(VDF-tetrafluoroethylene). They improve the piezoelectric response by improving the crystallinity of the material.

A novel electrospun TPU/PVdF porous fibrous polymer electrolyte for lithium ion batteries. Novel blend-based gel polymer electrolyte (GPE) films of thermoplastic polyurethane (TPU) and poly(vinylidene fluoride) (PVdF) (denoted as TPU/PVdF) have been prepared by electrospinning. The electrospun thermoplastic polyurethane-co-poly (vinylidene fluoride) membranes were activated with a 1M solution of LiClO4 in EC/PC and showed a high ionic conductivity about 1.6 mS cm-1 at room temperature. The electrochemical stability is at 5.0 V versus Li+/Li, making them suitable for practical applications in lithium cells. Cycling tests of Li/GPE/LiFePO4 cells showed the suitability of the electrospun membranes made of TPU/PVdF (80/20, w/w) for applications in lithium rechargeable batteries.

A novel high-performance gel polymer electrolyte membrane basing on electrospinning technique for lithium rechargeable batteries. Nonwoven films of composites of thermoplastic polyurethane (TPU) with different proportion of poly(vinylidene fluoride) (PVdF) (80, 50 and 20%, w/w) are prepared by electrospinning 9 wt % polymer solution at room temperature. Then the gel polymer electrolytes (GPEs) are prepared by soaking the electrospun TPU-PVdF blending membranes in 1 M LiClO4/ethylene carbonate (EC)/propylene carbonate (PC) for 1 h. The gel polymer electrolyte (GPE) shows a maximum ionic conductivity of 3.2×10-3 S cm-1 at room temperature and electrochemical stability up to 5.0 V versus Li+/Li for the 50:50 blend ratio of TPU:PVdF system. At the first cycle, it shows a first charge-discharge capacity of 168.9 mAh g-1 when the gel polymer electrolyte (GPE) is evaluated in a Li/PE/lithium iron phosphate (LiFePO4) cell at 0.1 C-rate at 25° C. TPU-PVdF (50:50, w/w) based gel polymer electrolyte is observed much more suitable than the composite films with other ratios for high-performance lithium rechargeable batteries.

### OBJECTS AND SUMMARY OF THE INVENTION

The present invention antenna vessel circuitry has been accomplished under the circumstances in view. According to one aspect of the present invention, the multipurpose XTS receiver is optionally equipped with a LED lamp and a rechargeable battery for illumination. According to another aspect of the present invention, the multipurpose receiver comprises a power control unit, which uses a piezoelectric component to amplify power for charging the rechargeable battery when battery power is low and when electric service supply is not available.

According to still another aspect of the present invention XTS system, the multipurpose Power frequency receiver comprises a circuit unit for receiving Power broadcasting signals, and a function mode touch display unit, which uses a speaker for voice output, a screen for data display, controller, processor and a selector key for frequency selection. An electrocardiogram (EKG or ECG) is a test that checks for problems with the electrical activity of your heart. An EKG translates the heart's electrical activity into line tracings on paper. The spikes and dips in the line tracings are called waves.

The present invention provides a stimulating pulse having frequency components falling within predetermined frequency band limits.

### BRIEF DESCRIPTION OF THE DRAWINGS

FIGS. 1-5 are views of antenna tube transducers according to the present invention.

FIG. 6 is a block schematic circuitry diagram of the transducer according to the invention.

FIG. 7 is a power frequency circuit diagram according to the present invention.

FIG. 8 is a power frequency circuit diagram according to the present invention.

FIG. 9 is a schematic circuitry diagram of a EKG transducer according to the invention.

### BRIEF DESCRIPTION OF THE INVENTION

Piezoelectric transducer tube bulb(silica, pvdf) with antenna embedded or atopic of a piezoelectric ceramic base oscillator. The “Piezode” alternately contains filaments (halogen, mercury, tungsten), Low pressure inert gas (argon, nitrogen, krypton, xenon) and stand alone functionality comprising touch screen, transceiver, controller, processor, and button.

The source of radio frequencies convertible to direct current by the circuit shown may include sources of high frequency, low frequency (LF), very low frequency (VLF) and extremely low frequency (ELF) radio waves as well as seismic vibration of the earth's magnetic fields.

### DETAILED DESCRIPTION OF THE PREFERRED EMBODIMENT

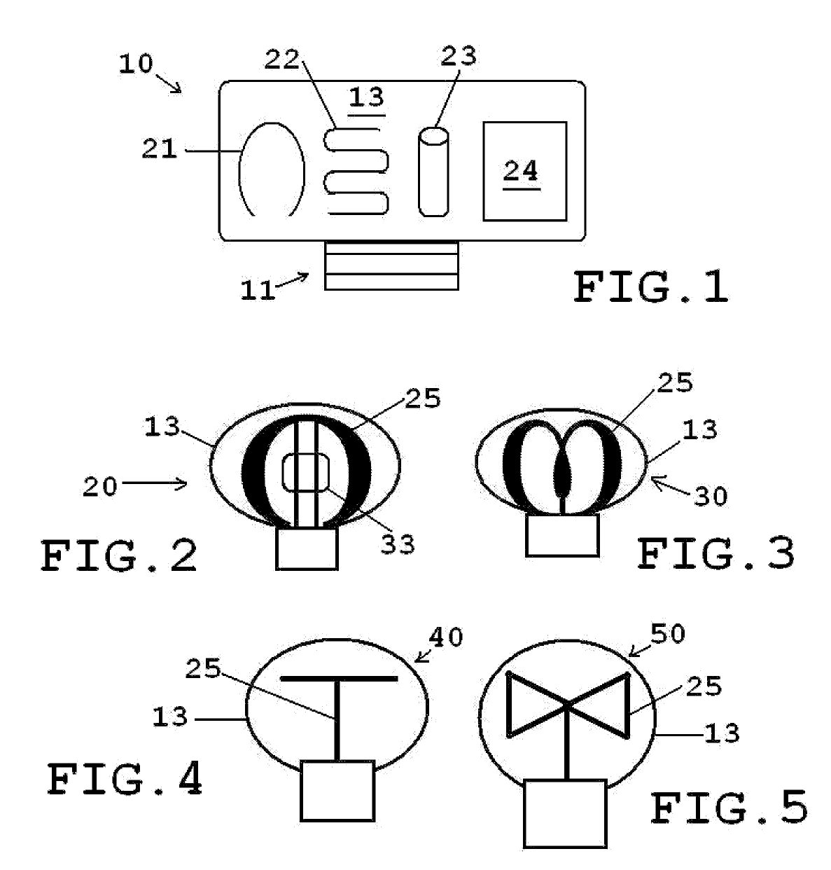

Referring to FIGS. 1-5, antenna piezoelectric tube 13 transducers 10,20,30,40,50 in accordance with the present invention is shown comprising bulb 13, optional filament 21, grid 22, cathode 23, plate 24, antenna 25 and piezoelectric stack base 11. The hand held base 11 houses a power control unit 100,200,300,400, a frequency power circuit unit electromotor 15, and a function mode display unit 17.

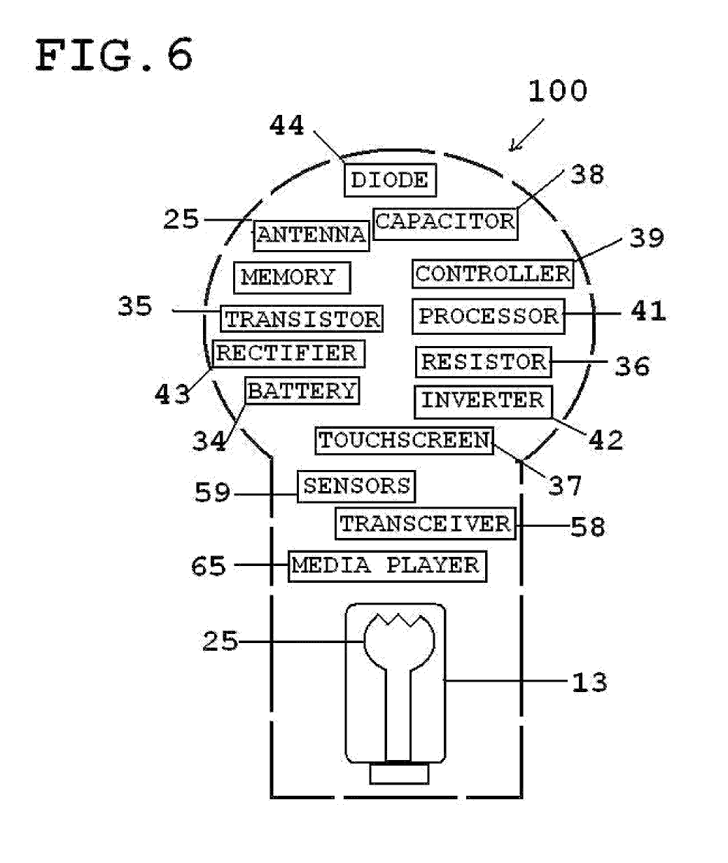

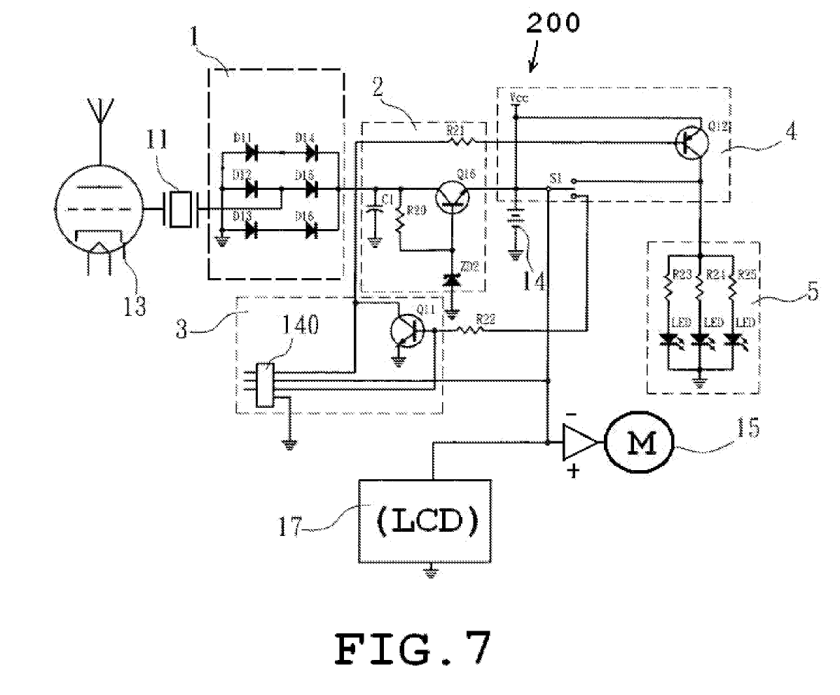

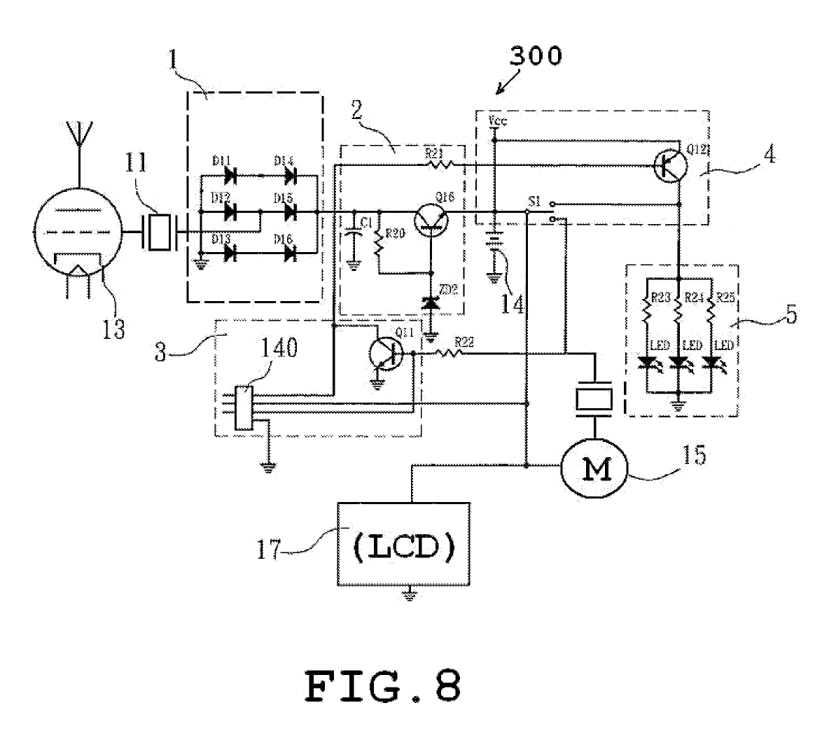

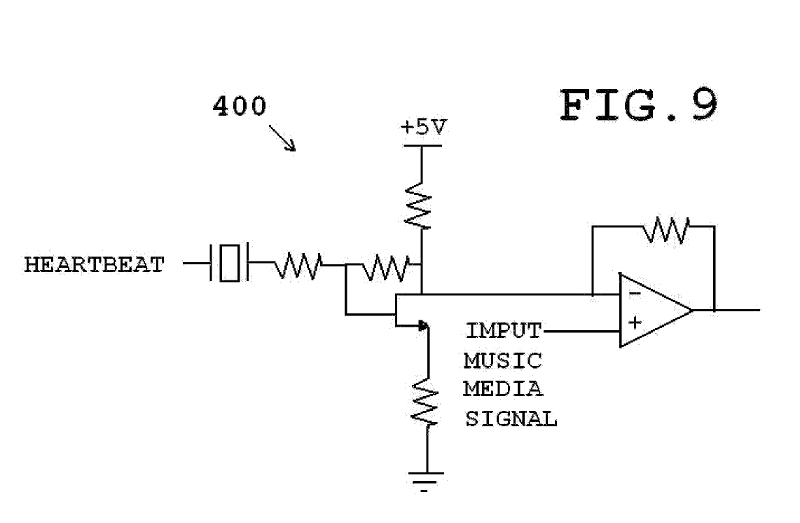

The FIGS. 6-9 power control unit 100,200,300,400 comprises a dynamo (11,13,25), a rectifier 1, charging circuit 2, an AC 26 supply charging circuit 3, a power lighting circuit 4, and a LED lamp 5. Antenna 25 tube 13 transducers 13 is coupled to the piezoelectric 11 through a bond set 12. The rectifier 1 is comprised of diodes D11-D16 and adapted to rectify AC 26 into DC 27. The antenna 25 vessel tube 13 charging circuit 2 is comprised of a transistor Q16 and a Zener diode ZD2. The antenna tube transducer charging circuit 2 is on when the dynamo (11,13,25) is on, continual. While the tube vessel 13 dynamo (11,13,25) is working, the antenna 25 charging circuit 2 is driven to charge the battery 14 with the output DC 27 power supply of the dynamo (11,13,25). The AC 26 supply charging circuit 3 is comprised of a transistor Q11 and an electric connector 140, and electrically 31 connect able to the socket 21 of a power adapter 333, which is connect able to electric 31 service supply for enabling the AC 26 supply charging circuit 3 to charge the battery 14 with electric 31 service supply. The lighting circuit 4 is comprised of a transistor Q12, which is turned on or turns off. The LED lamp 5 is comprised of multiple LEDs (Light Emitting Diodes).

Further, the LED lamp 5 and the power lighting circuit 4 are electrically connected in series to a selector switch S1, which can be switched between a first mode where the LED lamp 5 is automatically turned on, and a second mode where the LED lamp 5 is turned on constantly so that the multipurpose Receiver 32 is used as a light source. Thus, the circuit unit electromotor 15 is adapted to receive converted DC 27 from power broadcasting signals 28, etc. The function mode display(LCD) unit 17 has a speaker 16 for voice output, a screen 18 for data display, and a selector key 19 for frequency selection.

### Antenna Vessel Handheld Function:

With these FIGS. 1-5 objects in view my invention comprises a receptacle inclosing a sensitive gaseous conducting medium, the conductivity of which does not necessarily depend upon the heat 71 of combustion, although such conductivity may be increased by heating said gaseous 55 medium, and which in some cases requires practically no heating 71 at all, a wave 29-intercepting means associated with said gaseous conducting medium, whereby the feeble electrical currents or oscillations 45 resulting from the energy absorbed from electromagnetic signal 28 waves 29 may be impressed upon said gaseous conducting medium to alter its conductivity, and a signal indicating device operatively connected with said gaseous conducting medium, whereby alterations in the conductivity of the latter may be made manifest. The invention of an antenna 25 piezoelectric 11 vessel tube 13 when charged and amplified provides transistor and light means when said are combined with gases 55, filaments, cathodes, plates, anodes 51 earth element minerals 74: and a halogen or xenon light bulb consisting essentially of capsules 33.

An oscillation-responsive device comprising a receptacle inclosing a sensitive gaseous conducting medium containing a halogen; and apparatus for converting power frequency 101 energy into direct current for generating electric power, the apparatus comprising: antenna 25 input for receiving power frequency energy. An oscillation 45 detector 46 comprising an evacuated vessel 13, antenna 25 electrode, plate 24, cathode 23, grid 22, filament 21 inclosed there in, means for heating said electrode, a second electrode inclosed within said vessel, a local circuit 100, 200, 300, 400 having its terminals electrically, connected to said electrodes, a conducting member inclosed within said vessel 13 and located between said electrodes, and means for conveying the oscillations 45 to be detected to the first mentioned electrode and said conduction member. An oscillation 45 detector 46 comprising an evacuated vessel, antenna 25 filament sealed therein, a source of electrical energy connected in series with said filament, an electrode 21,22,23,24 sealed in said vessel, a local circuit having its terminals connected to said filament 21 and electrode, respectively, said local circuit including a source of electromotive force 88 and a signal 28 indicating device, a grid 22 of conducting material sealed in said vessel 13 and interposed between said filament and electrode, and means for conveying the oscillations to be detected to said filament and grid. An oscillation 45 detector 46 comprising an evacuated vessel, antenna 25 electrode, anode 51 plate 24, cathode, grid, filament inclosed therein, means for heating said electrode, a second electrode inclosed within said vessel, a local circuit having its terminals connected to said electrodes, a conducting member inclosed within said vessel and located between said, electrodes 70, a closed circuit far conveying the oscillations to be detected 75 to said first mentioned electrode and conducting member, and anode 51 piezoelectric 11 condenser in said closed circuit 100,200,300,400.

The halogen light bulb of the present has a halogen capsule's 33 filament structure which is substantially more stable than its standard incandescent counterpart, ensuring a long life. The oscillating circuit 100,200,300,400 receiver 32 a signal 28 at a frequency 101 of, for instance, 75 kHz as resonant frequency 101 of the piezoelectric 11 transducer 10 anode 51 (determined by the length direction dimension) or the neighborhood (±5 kHz) of the resonant frequency 101.

### DESCRIPTION OF ALTERNATE EMBODIMENTS

According to another aspect of the FIGS. 6-9 present invention, the multipurpose “Piezode” receiver comprises a self recharging phone 60 or ballast 56 with processor 41, controller 39, resistor 36, touchscreen 37, transistor 35, power inverter 42, capacitor 38, diodes 44, rectifier 43, transceiver 58, sensor 59, microphone 66, voice commands 67, camera 68, transformer 73. Silicon 72 is a semiconductor. It has a negative temperature coefficient of resistance, since the number of free charge carriers increases with temperature. The electrical resistance of single crystal silicon 72 significantly changes under the application of mechanical stress due to the piezoresistive effect. The coated glass bulbs 57 have a white or gray powdery substance on the inside called kaolin 52, phosphor 53 or getter 54. Kaolin, that is blown in and electrostatically deposited on the interior of the bulb 57.

An exemplary electrode 70 adapted to apply electrical energy. A measurement piezoelectric sensor 59 circuit is adapted to measure tissue. A processor 41 determines a heartbeat 61 and mood 64 condition for the target tissue based at least in part on reactance of the EKG 62 measured by the measurement circuit and auto selects 74 optimal media 65 appropriate genre/play lists entertainment. An ECG 63 is a way to measure and diagnose rhythms of the heartbeat 61. The ECG device detects and the amplifies tiny electrical changes on the skin that are caused when the heart muscle depolarizes during each heartbeat. At rest, each heart muscle cell 69 has a negative charge, called the membrane potential.

From the foregoing description, one skilled in the art can easily ascertain the essential characteristics of this invention, and without departing from the spirit and scope thereof, can make various changes and modifications of the invention to adapt it to various usages and conditions.

I claim:

1. A method of power frequency transition where energy is transmitted, received, amplified, capacitated for the continuance electro battery charging and operation of appliances, machinery, transportation, vehicles, electronics and where:
(a) a power frequency receiver comprising: a power control unit, said power control unit comprising a dynamo, Antenna within a piezoelectric vacuum tube transmission coupled to said dynamo to generate electricity, a rechargeable battery, a rectifier comprised of a plurality of diodes electrically connected between said dynamo and said rechargeable battery and adapted to rectify AC into DC, antenna vessel piezoelectric transducer power frequency charging circuit comprised of a transistor and a Zener diode and electrically connected between said rectifier and said rechargeable battery for charging said rechargeable battery during operation of said dynamo, adapter for converting electric service supply into DC power supply, a electric service AC supply charging circuit comprised of a transistor and an electric plug and adapted to charge said rechargeable battery with electric service supply, a LED lamp comprised of a plurality of light emitting diodes and, lighting circuit comprised of a transistor is turned on constantly where a electromotor circuit unit adapted to receive converted DC from power frequency broadcasting signals, and has a function mode display unit, said function mode display unit comprising a speaker for voice output, a screen for data display, and a selector key for frequency selection; and
(b) a Xeno Transducer system of power frequency reception and conversion to current.

2. I claim the invention of an antenna piezoelectric vessel tube when charged and amplified provides transistor and light means when said are combined with gases, filaments, cathodes, plates, earth element minerals: and
(a) antenna light bulb consisting essentially of gas capsules; and
(b) antenna vessel oscillation-responsive device comprising a receptacle inclosing a sensitive gaseous conducting medium; and.
(c) Antenna vacuum oscillation-responsive device comprising a receptacle inclosing a sensitive gaseous conducting medium containing a halogen and means for heating said medium; and
(d) antenna light consisting essentially of phosphor, getter and/or kaolin coating; and

3. EKG phone apparatus for converting power frequency energy into direct current for generating electric power, oscillation apparatus comprising: antenna input for receiving frequency energy:
(a) an oscillation detector comprising an evacuated vessel, antenna electrode, plate, cathode, grid, filament inclosed there in, means for heating said electrode, a second electrode inclosed within said vessel, a local circuit having its terminals electrically, connected to said electrodes, a conducting member inclosed within said vessel and located between said electrodes, and means for conveying the oscillations to be detected to the first mentioned electrode and said conduction member; and
(b) an oscillation detector comprising an evacuated vessel, antenna filament sealed therein, a source of electrical energy connected in series with said filament, antenna electrode, plate, cathode, grid, filament sealed in said vessel, a local circuit having its terminals connected to said filament and electrode, respectively, said local circuit including a source of electromotive force and a signal indicating device, a grid of conducting material sealed in said vessel and interposed between said filament and electrode, and means for conveying the osculations to be detected to said filament and grid; and
(c) an oscillation EKG phone detector comprising an evacuated vessel, antenna electrode, plate, cathode, grid, filament inclosed therein, means for heating said electrode, a second electrode inclosed within said vessel, a local circuit having its terminals connected to said electrodes, a conducting member inclosed within said vessel and located between said, electrodes, a closed circuit far conveying the oscillations to be detected to said first mentioned electrode and conducting member, and piezoelectric anode condenser in said closed circuit; and
(d) an EKG handheld measurement device, comprising an EKG electrode that generates an EKG, mood auto select media unit communicated to the device that generates a mood signal based on the sensor heartbeat signal; and.
(e) an EKG cell phone device, comprising an EKG electrode that generates an EKG, mood auto select media unit communicated to the device that generates a mood signal based on the sensor heartbeat signal.
